(19) United States
(12) Patent Application Publication
(10) Pub. No.: US 2013/0073629 A1
(43) Pub. Date: Mar. 21, 2013

(54) System and Method for Friend Recommendation in Social Network Service Network

(71) Applicant: Tencent Technology (Shenzhen) Company Limited, Shenzhen (CN)

(72) Inventors: Haicheng Su, Shenzhen (CN); Zhihao Zheng, Shenzhen (CN)

(73) Assignee: Tencent Technology (Shenzhen) Company Limited, Shenzhen (CN)

(21) Appl. No.: 13/675,078

(22) Filed: Nov. 13, 2012

Related U.S. Application Data
(63) Continuation of application No. PCT/CN2011/072928, filed on Apr. 18, 2011.

(30) Foreign Application Priority Data
May 25, 2010 (CN) 201010182734.8

(51) Int. Cl. G06F 15/16

(52) U.S. Cl. 709/204

(57) ABSTRACT

A system for friend recommendation in a Social Network service (SNS) network includes a server and clients. The server includes: an aggregation container database used for aggregating user information stored in the server in the SNS network; an obtaining module used for selecting user information from the aggregation container database as temporary friend information; a push module used for pushing the temporary friend information once obtained by the obtaining module, to the client directly. The client includes a data display unit used for displaying after the client receives the temporary friend information. With the application of the system, initiative aggregation of the user information in the server can be performed to generate the aggregation container database, and then the temporary friend information can be pushed to the client actively, thus the temporary friend information can be obtained without the initiative search of the user who user the client.

### FIELD OF THE INVENTION

The present invention relates to computer input technology, and more particular to a system and method for friend recommendation in social network service network.

### BACKGROUND ART

Social network service (referred to as “SNS”) is technical application architecture in web2.0 system. By establishment of direct social friend relationship and sharing human resources among friends, SNS completes or solves specific application problems in the process of establishment of social relations. Through the use of SNS, personal data processing, personal social relationship management, credible business information sharing, safely sharing one's own information and knowledge to trusted people, and expanding one's own social network using trusted relationship can be realized, thereby reach a more valuable communication and collaboration.

As shown in FIG. 1, FIG. 1 shows a block diagram of a system for friend recommendation in existing SNS network.

After a user logs in the SNS network, the user needs to actively fill in conditions of friends who the user wants to search, a data obtaining unit 12 obtains user information which meets the user's search condition from a user information database 11 of a server according the search condition filled in by the user, and this part of user information is displayed through a data display unit 20 of a client to the user for users to select and add friends.

In the existing SNS network, SNS users must actively search friends, then add the friends, the relationship can be confirmed only after obtaining confirmation of the target, the threshold of adding a friend is higher; thus, friends of an SNS new registered user may be few (such as new registered users from foreign), the user viscosity and active degrees can't be improved, the role of the SNS can not be fully played.

### SUMMARY

The technical problem to be solved by one embodiment of the present invention is to provide a system and method for friend recommendation in an SNS network, aiming at the problem of the above system for friend recommendation in SNS network that it depends on users to actively search friends, and cannot improve user viscosity and active degrees and cannot fully play the role of the SNS.

In order to solve the above technical problem, the present invention provides a system and method for friend recommendation in an SNS network, including a server and a client;

wherein the server comprising:

an aggregation container database used for aggregating user information stored in the server in the SNS network;

an obtaining module used for selecting user information from the aggregation container database as temporary friend information;

a push module used for directly pushing the temporary friend information to the client after the obtaining module obtains the temporary friend information;

the client comprises:

a data display unit used for displaying the temporary friend information after the client receives the temporary friend information.

Accordingly, the present invention also provides a method for friend recommendation in an SNS network, the method is applicable to a system for friend recommendation in the SNS network which includes a server and a client, the method includes:

aggregating user information stored in the server to generate an aggregation container database;

selecting user information from the aggregation container database as temporary friend information;

directly pushing the temporary friend information to the client after obtaining the temporary friend information;

displaying, by the client, the temporary friend information after the client receives the temporary friend information.

In the implementation of the embodiment of the present invention, the user information stored in the server is first aggregated to generate the aggregation container database, then user information is actively selected from the aggregation container database as temporary friend information and is actively pushed to the client, thereby realizing that the temporary friend information can be obtained without the initiative search of the user who user the client, improving timeliness and convenience of friend recommendation in an SNS network.

### BRIEF DESCRIPTION OF THE DRAWINGS

In order to more clearly illustrate embodiments of the present invention, the figures which are needed to be used in the description of the embodiments will be briefly described in the following. Obviously, the figures in the following description are only some embodiments of the present invention, and it is easily for those skilled in the art to obtain other figures based on the following figures without creative work.

FIG. 1 is a schematic diagram of a system for friend recommendation in existing SNS network;

FIG. 2 is a schematic diagram of a first embodiment of a system for friend recommendation in an SNS network of the present invention;

FIG. 3 is a schematic diagram of a second embodiment of the system for friend recommendation in an SNS network of the present invention;

FIG. 4 is a schematic flow chart of a first embodiment of a method for friend recommendation in an SNS network of the present invention;

FIG. 5 is a schematic flow chart of a second embodiment of the method for friend recommendation in an SNS network of the present invention.

### DETAILED DESCRIPTION OF EXAMPLES

To make the above objectives, technical solution and advantages of the present invention more clear, the present invention are hereinafter described in detail with reference to the accompanying drawings and embodiments.

The present invention first aggregates user information stored in a server to generate an aggregation container database, then actively selects user information from the aggregation container database as temporary friend information, and actively push the temporary friend information to the client, thereby realizing that the temporary friend information can be obtained without the initiative search of the user who user the client, improving timeliness and convenience of friend recommendation in an SNS network.

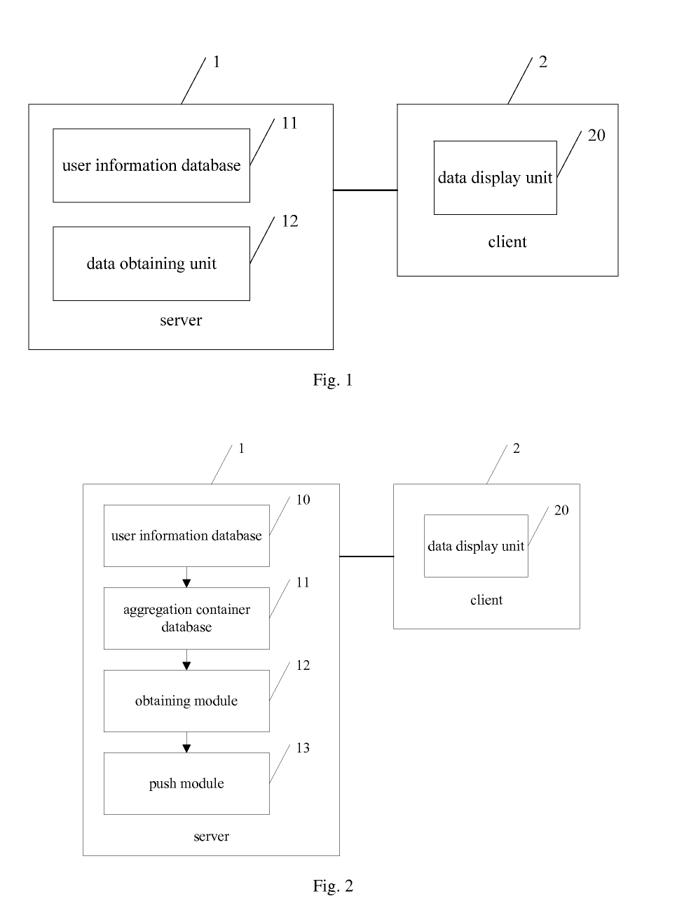

As shown in FIG. 2, FIG. 2 is a schematic diagram of a first embodiment of a system for friend recommendation in an SNS network of the present invention. The system includes:

a server 1 and a client 2, the server 1 includes:

an aggregation container database 11, used for aggregating user information stored in the server in the SNS network.

an obtaining module 12, used for selecting user information from the aggregation container database 11 as temporary friend information.

a push module 13, used for directly pushing the temporary friend information to the client 2 after the obtaining module 12 obtains the temporary friend information.

The client 2 includes a data display unit 20, used for displaying after the client 2 receives the temporary friend information.

The user information stored in the server 1 is stored through a user information database 10, and the user information database 10 is used to store personal information of all registered users of the SNS network, such as account number, nickname, profession, age, native place, and so on.

The aggregation container database 11 is automatically created, and aggregates user information in the user information database 10, especially user information of just registered users, so that the new registered users, as temporary friends, can be actively recommended to other SNS network users.

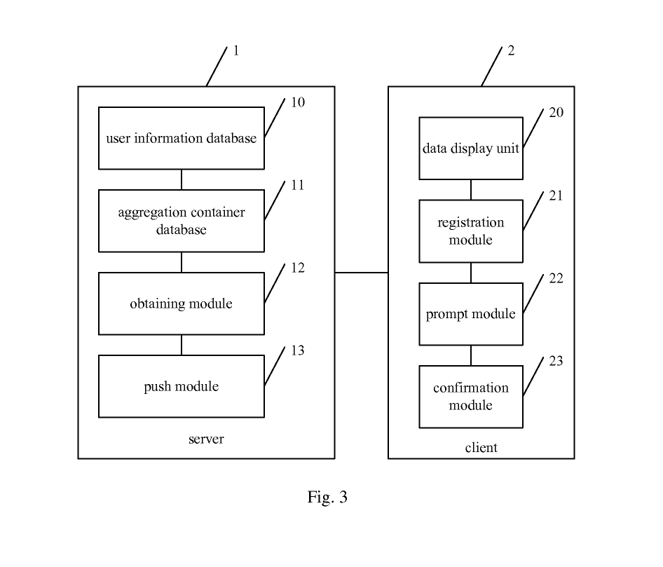

As shown in FIG. 3, FIG. 3 is a schematic diagram of a second embodiment of the system for friend recommendation in an SNS network of the present invention.

Similar to the first embodiment of the above system, this system includes a server 1 and a client 2; the server 1 includes an aggregation container database 11, an obtaining module 12 and a push module 13; the client 2 includes a data display unit 20; in this embodiment, the client 2 further includes:

a registration module 21, used for providing SNS application registration service for users;

a prompt module 22, used for prompting users who register the SNS network through the user registration module whether to need to add temporary friend information and/or to allow other users to add as a temporary friend.

a confirmation module 23, used for receiving a confirmation information that the user confirms to add temporary friend information and/or to allow other users to add as a temporary friend, and forwards it to the server 1.

After the aggregation container database 11 of the server 1 receives the confirmation information, the aggregation container database 11 aggregates the information of the user in the aggregation container database 11.

Specifically, a user first uses the registration module 21 of the client to register the SNS, when the user first enters an application or game of the SNS network after successful registration, the prompt module 22 of the client 2 can prompt once for each registered user whether to add friend list relationship to enrich his/her own application scope, and also prompt for the user whether to allow other user to add the user as a friend, if yes, the information of the user is aggregated in the aggregation container database 11.

Then, the obtaining module 12 of the server 1 randomly select user information from the aggregation container database 11 as temporary friend information, which is pushed to the client 2 through the information push module 13, the data display unit 20 of the client 2 display the temporary friend information after receiving the temporary friend information.

The client 2 further includes:

an add module 21, used for adding the temporary friend information to a temporary friend database of the client 2 after the data display unit 20 of the client 2 displays the temporary friend information and after the add module 21 receives the confirmation of the user to add temporary friend. The temporary friend database is used for storing temporary friend information of the client 2 which is fixed temporary friend relationship stored in the server, the server side sets up a temporary friend database fro each client.

It should be noted, the temporary friend information is nickname, and is not all the user information.

In the implementation of the embodiment of the present invention, the user information stored in the server is first aggregated to generate the aggregation container database 11, then user information is actively selected from the aggregation container database 11 as temporary friend information and is actively pushed to the client 2, thereby realizing that the temporary friend information can be obtained without the initiative search of the user who user the client 2, improving timeliness and convenience of friend recommendation in an SNS network.

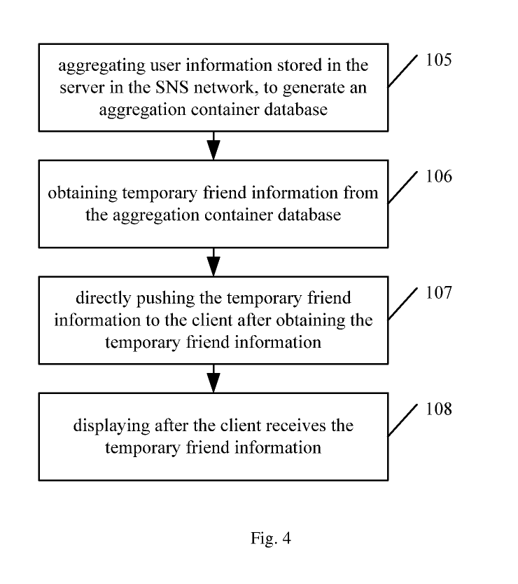

As shown in FIG. 4, FIG. 4 is a schematic flow chart of a first embodiment of a method for friend recommendation in an SNS network of the present invention;

The method for friend recommendation in an SNS network of the present invention can be applied in a friend recommendation in an SNS network which includes the server and clients, and includes following steps:

Step 105: aggregating user information stored in the server in the SNS network, to generate an aggregation container database.

Step 106: obtaining temporary friend information from the aggregation container database.

Step 107: directly pushing the temporary friend information to the client after obtaining the temporary friend information.

Step 108: displaying the temporary friend information after the client receives the temporary friend information.

The user information stored in the server of the SNS network is stored through a user information database, and the user information database is used to store personal information of all registered users of the SNS network, such as account number, nickname, profession, age, native place, and so on.

The aggregation container database is automatically created, and aggregates user information in the user information database, especially user information of just registered users, so that the new registered users, as temporary friends, can be actively recommended to other SNS network users.

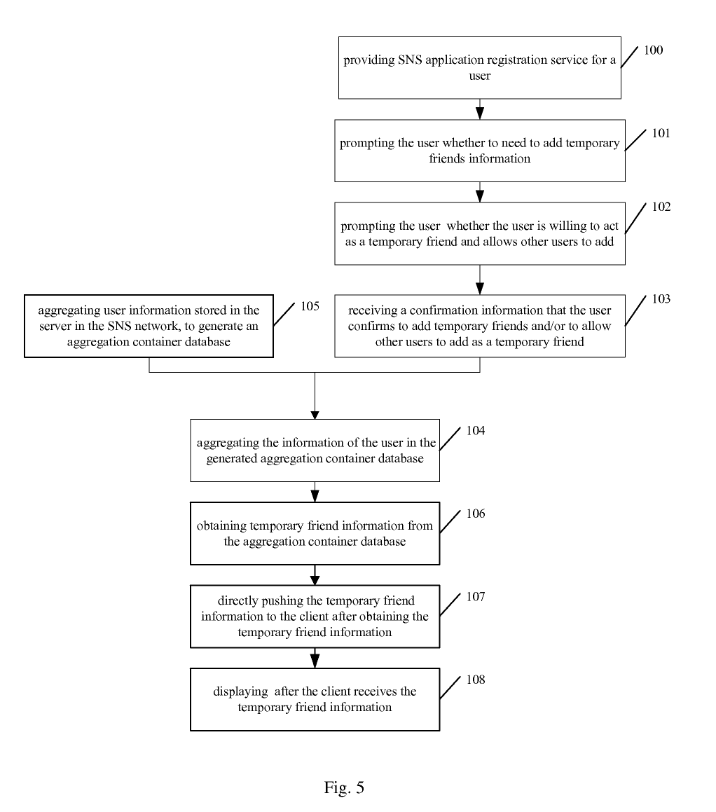

As shown in FIG. 5, FIG. 5 is a schematic flow chart of a second embodiment of the method for friend recommendation in an SNS network of the present invention.

Similar to the first embodiment of the above method, the method provided in this embodiment includes the above steps 105˜108; further, in this embodiment, after the aggregation container database is generated and before the temporary friend information is obtained from the aggregation container database, i.e. after the step 105 and before step 106, the method further includes step 104, and also includes steps 100˜103:

Step 100: providing SNS application registration service for a user;

Step 101: prompting the user who registers the SNS network whether to need to add temporary friend information.

Step 102: prompting the user who registers the SNS network whether the user is willing to act as a temporary friend and allows other users to add; it should be noted, there is no limit about the sequence between the step 101 and the step 102, in the process of implementation, the step 102 can be first performed and then the step 101 is performed; and not both of the step 101 and the step 101 are needed to be performed, in he process of implementation, it can only perform the step 101.

Step 103: receiving confirmation information that the user confirms to add temporary friends and/or to allow other users to add as a temporary friend.

Step 104: after receiving the confirmation information of allowing other users to add as a temporary friend and after the step of generating aggregation container database, aggregating the information of the user in the generated aggregation container database.

Specifically, the user first uses the client to register the SNS, when the user first enters an application or game of the SNS network after successful registration, the client can prompt once for each registered user whether to add friend list relationship to enrich his/her own application scope, and also prompt for the user whether to allow other user to add the user as a friend, if yes, the information of the user is aggregated in the aggregation container database. Once the user adds user information recommended from the aggregation container database as temporary friend information, then it does not need the user to confirm, and the user itself also automatically becomes a temporary friend of a user corresponding to the temporary friend information.

Then, the server randomly select user information from the aggregation container database as temporary friend information, which is pushed to the client, the client display the temporary friend information after receiving the temporary friend information.

The temporary friend information is added to a temporary friend database, which stores temporary friend information, of the client after the client displays the temporary friend information and after the client receives the confirmation of the user to add temporary friend, a user corresponding to the temporary friend information automatically becomes a temporary friend of the user. It should be noted, the temporary friend information is nickname, and is not all the user information.

The client can be a mobile phone client, and can also be a web client.

In the implementation of the embodiment of the present invention, the user information stored in the server is first aggregated to generate the aggregation container database, then user information is actively selected from the aggregation container database as temporary friend information and is actively pushed to the client, thereby realizing that the temporary friend information can be obtained without the initiative search of the user who user the client, improving timeliness and convenience of friend recommendation in an SNS network.

It can be understood by those skilled in the art that the whole or parts of the process of the method in the above embodiment can be realized by computer program instructing related hardware, the computer program is stored in a computer readable storage medium, when the program is executed, it can include such as process of the embodiment of the above each method. The storage medium can be diskette, compact disc, Read-Only Memory (ROM) or Random Access Memory (RAM), and so on.

The foregoing are only preferred embodiments of the present invention, it should be noted, for those skilled in the art, some improvements and refinements can also be made without departing from the principle of the present invention, and these improvements and refinements should fall within the scope of the present invention.

1. A system for friend recommendation in an SNS network, comprising a server and a client,
wherein the server comprising:
an aggregation container database used for aggregating user information stored in the server in the SNS network;
an obtaining module used for selecting user information from the aggregation container database as temporary friend information;
a push module used for directly pushing the temporary friend information to the client after the obtaining module obtains the temporary friend information;
the client comprises:
a data display unit used for displaying the temporary friend information after the client receives the temporary friend information.

2. The system according to claim 1, wherein the client further comprises:
a registration module used for providing SNS application registration service for a user;
a prompt module used for prompting the user who registers the SNS network through the registration module whether to need to add the temporary friend information and/or to allow other users to add as a temporary friend;
a confirmation module used for receiving a confirmation information that the user confirms to need to add the temporary friend information and/or to allow other users to add as a temporary friend, and forwarding it to the server;
after the aggregation container database of the server receives the confirmation information of allowing other users to add as a temporary friend, the aggregation container database aggregates information of the user in the aggregation container database.

3. The system according to claim 2, wherein the server further comprises:
an add module used for adding the temporary friend information to a temporary friend database, which stores the temporary friend information, of the client, after receiving the confirmation of the user to need to add the temporary friend information.

4. The system according to claim 3, wherein the temporary relationship obtaining module randomly obtains temporary friend information from the aggregation container database.

5. The system according to claim 1, wherein
the client is a mobile phone client or a web client.

6. A method for friend recommendation in an SNS network, the method comprising:
aggregating user information stored in the server to generate an aggregation container database;
selecting user information from the aggregation container database as temporary friend information;
pushing the temporary friend information to the client after obtaining the temporary friend information;
displaying, by the client, the temporary friend information after the client receives the temporary friend information.

7. The method according to claim 6, wherein the method further comprises:
providing SNS application registration service for a user;
prompting the user who registers the SNS network whether to need to add the temporary friend information and/or to allow other users to add as a temporary friend;
receiving a confirmation information that the user confirms to need to add the temporary friend information and/or to allow other users to add as a temporary friend;
aggregating information of the user in the generated aggregation container database after receiving the confirmation information of allowing other users to add as a temporary friend and after the step of generating the aggregation container database.

8. The method according to claim 7, wherein
adding the temporary friend information to a friend database, which stores the temporary friend information, of the client, after receiving the confirmation of the user to need to add temporary friend information.

9. The method according to claim 8, wherein user information is randomly selected from the aggregation container database as the temporary friend information.

10. The method according to claim 6, wherein
the client is a mobile phone client or a web client.

11. A server in an SNS network comprising:
an aggregation container database used for aggregating user information;
an obtaining module used for selecting user information from the aggregation container database as temporary friend information;
a push module used for pushing the temporary friend information after the obtaining module obtains the temporary friend information.

12. The server according to claim 11, further comprising a user information database used for storing personal information of all registered users of the SNS network;
wherein the aggregation container database is used for aggregating user information in the user information database.

13. The server according to claim 11, wherein the obtaining module randomly selects user information from the aggregation container database as the temporary friend information.

14. The server according to claim 11, wherein the obtaining module actively selects user information from the aggregation container database as the temporary friend information.

15. The server according to claim 11, wherein the push module actively pushes the temporary friend information after the obtaining module obtains the temporary friend information.
